(19) United States
(12) Patent Application Publication
(10) Pub. No.: US 2011/0289793 A1
(43) Pub. Date: Dec. 1, 2011

(54) SUPERCRITICAL DRYING METHOD

(76) Inventors: Hidekazu HAYASHI, Yokohama-Shi (JP); Hiroshi Tomita, Yokohama-Shi (JP); Hisashi Okuchi, Yokohama-Shi (JP); Yohei Sato, Yokohama-Shi (JP); Yukiko Kitajima, Komatsu-Shi (JP)

(21) Appl. No.: 12/976,593

(22) Filed: Dec. 22, 2010

(30) Foreign Application Priority Data
May 25, 2010 (JP) 2010-119317

(51) Int. Cl. F26B 3/02; B08B 3/10

(52) U.S. Cl. 34/357; 134/30

(57) ABSTRACT

According to one embodiment, a semiconductor substrate having a surface wetted with a chemical solution is introduced into a chamber, and a supercritical fluid is supplied into the chamber. The temperature in the chamber is adjusted to the critical temperature of the chemical solution or higher, so that the chemical solution is put into a supercritical state. The pressure in the chamber is then lowered, and the chemical solution in the critical state is turned into gaseous matter. The gaseous matter is then discharged from the chamber.

### CROSS REFERENCE TO RELATED APPLICATION

This application is based upon and claims benefit of priority from the Japanese Patent Application No. 2010-119317, filed on May 25, 2010, the entire contents of which are incorporated herein by reference.

### FIELD

Embodiments described herein relate generally to a supercritical drying method.

### BACKGROUND

The procedures for manufacturing a semiconductor device include various procedures such as a lithography procedure, an etching procedure, and an ion implanting procedure. After the end of each procedure, a cleaning procedure and a drying procedure are carried out to remove impurities and residues from the wafer surface and clean the wafer surface prior to the start of the next procedure.

For example, in the wafer cleaning process after the etching procedure, a chemical solution for the cleaning process is supplied onto the surface of the wafer, and pure water is then supplied to perform a rinsing process. After the rinsing process, the drying process is performed by removing the remaining pure water from the wafer surface and drying the wafer.

By a known method of performing the drying process, the pure water on the wafer is substituted for isopropyl alcohol (IPA), and the wafer is dried, for example. During this drying process, however, the pattern formed on the wafer collapse with the surface tension of the liquid.

To counter this problem, supercritical drying that causes no surface tension has been suggested. For example, a wafer having its surface wetted with IPA is immersed in carbon dioxide in a supercritical state (a supercritical CO₂ fluid) in a chamber, so that the IPA on the wafer is dissolved in the supercritical CO₂ fluid. After that, the pressure and temperature in the chamber are lowered, and the supercritical CO₂ fluid having the IPA dissolved therein is phase-transformed into a gas. The gas is then discharged from the chamber, and the wafer is dried.

However, when the pressure inside the chamber is reduced, and the carbon dioxide is phase-transformed from the supercritical state into a gaseous state, the IPA remaining in the chamber is agglutinated and re-adsorbs onto the wafer, and particles are formed.

### BRIEF DESCRIPTION OF THE DRAWINGS

FIG. 1 is a state diagram showing the relationships among pressure, temperature, and the phase states of substances;

FIG. 2 is a schematic view showing the structure of a supercritical drying system according to an embodiment of the present invention;

FIG. 3 is a flowchart for explaining a method of cleaning and drying a semiconductor substrate according to the embodiment; and

FIG. 4 is a state diagram of carbon dioxide and IPA.

### DETAILED DESCRIPTION

According to one embodiment, a semiconductor substrate having a surface wetted with a chemical solution is introduced into a chamber, and a supercritical fluid is supplied into the chamber. The temperature in the chamber is adjusted to the critical temperature of the chemical solution or higher, so that the chemical solution is put into a supercritical state. The pressure in the chamber is then lowered, and the chemical solution in the critical state is turned into gaseous matter. The gaseous matter is then discharged from the chamber.

The following is a description of the embodiment of the present invention, with reference to the accompanying drawings.

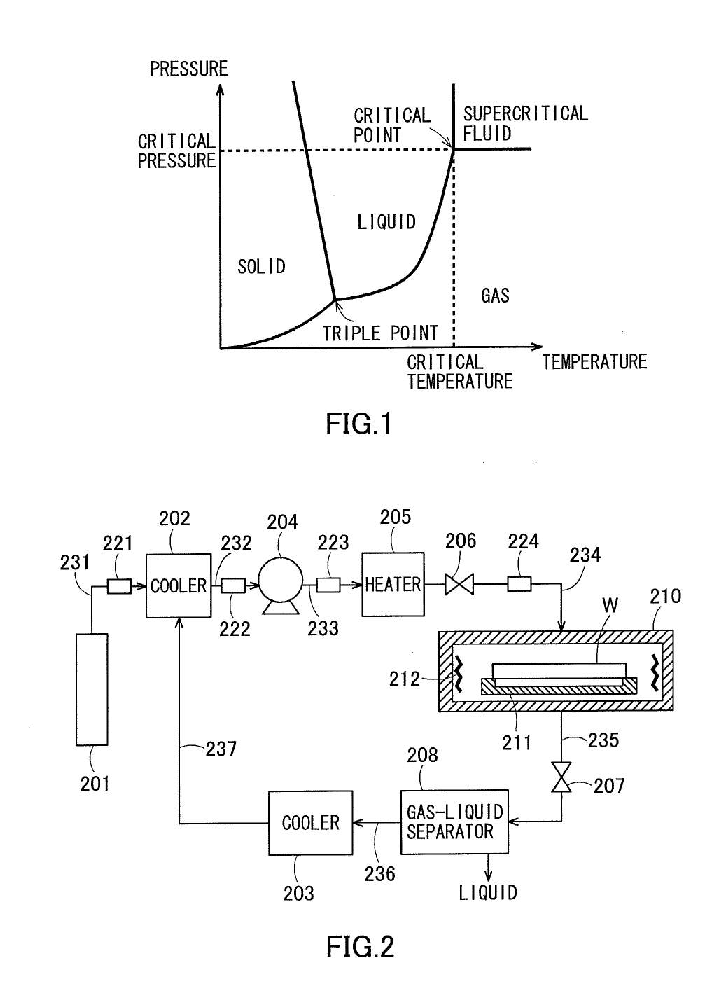

First, supercritical drying is described. FIG. 1 is a state diagram showing the relationships among the pressure, the temperature, and the phase states of substances. The functional substance of a supercritical fluid used for supercritical drying has the so-called three states of matter: a gaseous phase (gaseous matter), a liquid phase (liquid matter), and a solid phase (solid matter).

As shown in FIG. 1, the above described three phases are separated by a vapor pressure curve (a gas-phase equilibrium line) representing the boundary between the gaseous phase and the liquid phase, a sublimation curve representing the boundary between the gaseous phase and the solid phase, and a dissolution curve representing the boundary between the solid phase and the liquid phase. The point where the three phases overlap with one another is the triple point. Extending from the triple point toward the high-temperature side, the vapor pressure curve reaches the critical point that is the limit of coexistence of the gaseous phase and the liquid phase. At this critical point, the density of the gaseous phase becomes equal to the density of the liquid phase, and the interface in a gas-liquid coexistence state disappears.

In a state where the temperature and the pressure are both higher than the critical point, the boundary between the gaseous phase and the liquid phase disappears, and the substance turns into a supercritical fluid. A supercritical fluid is a fluid compressed at high density at the critical temperature or higher. A supercritical fluid is similar to gaseous matter in that the spreading force of the solvent molecules is dominant. On the other hand, a supercritical fluid is similar to liquid matter in that the influence of the molecular cohesion cannot be ignored. Accordingly, a supercritical fluid has properties that dissolve various kinds of substances.

A supercritical fluid also characteristically has much higher lubricity than liquid matter, and easily permeates a minute structure.

A supercritical fluid can also dry a minute structure, without breaking the minute structure, by transforming from a supercritical state directly to a gaseous phase, so as not to form an interface between the gaseous matter and the liquid matter or not to cause a capillary force (surface tension). Supercritical drying is to dry a substrate by taking advantage of the supercritical state of such a supercritical fluid.

A supercritical fluid selected to be used for the supercritical drying may be carbon dioxide, ethanol, methanol, propanol, butanol, methane, ethane, propane, water, ammonia, ethylene, fluoromethane, or the like.

Particularly, carbon dioxide has a relatively low critical temperature of 31.1° C. and a relatively low critical pressure of 7.37 MPa, and therefore, can be readily processed. In this embodiment, carbon dioxide is used, but any other one of the above mentioned substances may be used as a supercritical fluid.

FIG. 2 schematically shows the structure of a supercritical drying system according to the embodiment of the present invention. The supercritical drying system includes a gas cylinder 201, coolers 202 and 203, a pressure raising pump 204, a heater 205, valves 206 and 207, a gas-liquid separator 208, and a chamber 210.

The cylinder 201 stores carbon dioxide in a gaseous state. The pressure raising pump 204 sucks out the carbon dioxide, raises the pressure, and discharges the carbon dioxide from the cylinder 201. The carbon dioxide sucked out from the cylinder 201 is supplied to the cooler 202 via a pipe 231, is cooled, and is then supplied to the pressure raising pump 204 via a pipe 232.

The pressure raising pump 204 raises the pressure to the critical pressure of the carbon dioxide or higher, and then discharges the carbon dioxide. The carbon dioxide discharged from the pressure raising pump 204 is supplied to the heater 205 via a pipe 233. The heater 205 raises the temperature of (or heats) the carbon dioxide to its critical temperature or higher. As a result, the carbon dioxide is put into a supercritical state.

The supercritical carbon dioxide discharged from the heater 205 is supplied to the chamber 210 via a pipe 234. A valve 206 is attached to the pipe 234. The valve 206 adjusts the supply of the supercritical carbon dioxide to the chamber 210.

The pipes 231 through 234 have respective filters 221 through 224 that remove particles.

The chamber 210 is a high-pressure container made of SUS. The chamber 210 has a stage 211 and a heater 212. The stage 211 is a ring-shaped flat plate that holds a substrate W to be processed. The heater 212 can adjust the temperature in the chamber 210. The heater 212 may be provided in the outer peripheral portion of the chamber 210.

The gaseous matter and the supercritical fluid in the chamber 210 are discharged via a pipe 235. A valve 207 is attached to the pipe 235. The pressure in the chamber 210 can be adjusted by adjusting the opening of the valve 207. The supercritical fluid turns into gaseous matter on the downstream side of the valve 207 of the pipe 235.

The gas-liquid separator 208 separates gaseous matter and liquid matter from each other. For example, when supercritical carbon dioxide having alcohol dissolved therein is discharged from the chamber 210, the gas-liquid separator 208 separates the alcohol in a liquid state and the carbon dioxide in a gaseous state from each other. The separated alcohol can be reused.

The gaseous carbon dioxide discharged from the gas-liquid separator 208 is supplied to the cooler 203 via a pipe 236. The cooler 203 cools the carbon dioxide and puts the carbon dioxide into a liquid state. The cooler 203 then discharges the carbon dioxide to the cooler 202 via a pipe 237. The carbon dioxide discharged from the cooler 203 is also supplied to the pressure raising pump 204. With this structure, the carbon dioxide can be cyclically used.

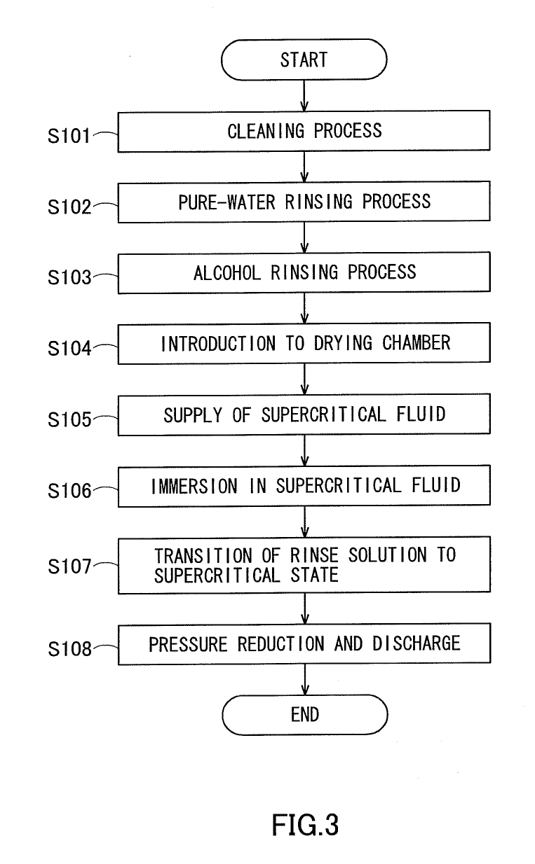

FIG. 3 is a flowchart for explaining a method of cleaning and drying a semiconductor substrate according to this embodiment.

(Step S101) A semiconductor substrate to be processed is introduced into a cleaning chamber (not shown). A cleaning process is performed by supplying a chemical solution onto the surface of the semiconductor substrate. The chemical solution may be sulfuric acid, fluoric acid, hydrochloric acid, hydrogen peroxide, or the like.

Here, the cleaning process includes a process to remove a resist from the semiconductor substrate, a process to remove particles and metal impurities, a process to remove a film formed on the substrate through etching, and the like.

(Step S102) Pure water is supplied onto the surface of the semiconductor substrate, and a pure-water rinsing process is performed by washing away the remaining chemical solution from the surface of the semiconductor substrate with the pure water.

(Step S103) Alcohol is supplied onto the surface of the semiconductor substrate, and an alcohol rinsing process is performed by substituting the pure water remaining on the surface of the semiconductor substrate for alcohol. The alcohol used here is dissolved in (or easily substituted for) both pure water and a supercritical carbon dioxide fluid. In this embodiment, isopropyl alcohol (IPA) is used.

(Step S104) With the surface being wetted with IPA, the semiconductor substrate is pulled out from the cleaning chamber in such a manner as not to let the semiconductor substrate dry naturally. The semiconductor substrate is then introduced into the chamber 210 of the supercritical drying system shown in FIG. 2, and is fixed onto the stage 211.

(Step S105) The pressure of the carbon dioxide gas in the cylinder 201 is raised by the pressure raising pump 204, and the temperature of the carbon dioxide gas in the cylinder 201 is raised by the heater 205, so that the carbon dioxide gas turns into a supercritical fluid. The supercritical fluid is then supplied into the chamber 210 via the pipe 234.

(Step S106) The semiconductor substrate is immersed in the carbon dioxide as the supercritical fluid (in a supercritical state) for a predetermined period of time, or about 20 minutes, for example. As a result, the IPA on the semiconductor substrate is dissolved in the supercritical fluid, and is removed from the semiconductor substrate. In this manner, the semiconductor substrate is dried.

At this point, while the supercritical fluid is being supplied into the chamber 210 via the pipe 234, the valve 207 is opened so as to gradually discharge the supercritical fluid having IPA dissolved therein from the chamber 210 via the pipe 235.

(Step S107) The temperature in the chamber 210 is changed so that the rinse solution (supercritical substitution solvent) used in step S103 is put into a supercritical state. Since IPA is used as the rinse solution here, the temperature and pressure in the chamber 210 are adjusted to the critical point of IPA (235.2° C., 4.76 MPa). Specifically, the valves 206 and 207 are closed to prevent the pressure in the chamber 210 from becoming lower, and the temperature in the chamber 210 is raised to the critical temperature of IPA or higher by the heater 212.

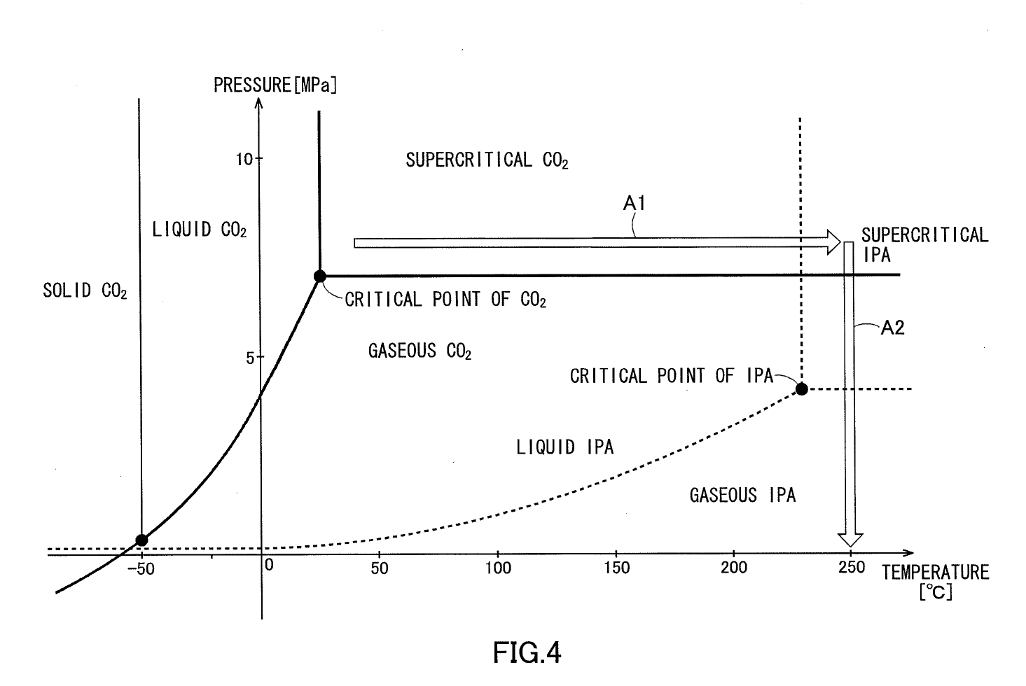

FIG. 4 is a state diagram showing the relationships among the pressure, the temperature, and the phase state of each of carbon dioxide and IPA. In FIG. 4, the solid lines represent the carbon dioxide, and the broken lines represent the IPA. In this step, the temperature in the chamber 210 should be raised to the critical temperature of IPA or higher while a pressurized state where the pressure is equal to or higher than the critical pressure of carbon dioxide is maintained as indicated by the arrow A1 in FIG. 4, so that the carbon dioxide is not put into a gaseous state before the IPA is put into a supercritical state.

This is because, if the carbon dioxide is put into a gaseous state before the IPA is put into a supercritical state or while the IPA is in a liquid state, the liquid IPA remaining in the chamber 210 while being dissolved in the supercritical carbon dioxide adheres onto the semiconductor substrate. After the IPA is put into a supercritical state, the carbon dioxide may be put into a gaseous state.

(step S108) The valve 207 is opened to lower and return the pressure in the chamber 210 to atmospheric pressure (see the arrow A2 in FIG. 4). The carbon dioxide and IPA in the chamber 210 are then put into a gaseous state. For example, when the pressure in the chamber 210 is reduced, the temperature in the chamber 210 is maintained at the critical temperature of IPA or higher. With this arrangement, the IPA does not transit from the supercritical state to a liquid state, but transits to a gaseous state, as can be seen from FIG. 4. The carbon dioxide and IPA in the gaseous state in the chamber 210 are then discharged (exhausted). At this point, the process to dry the substrate is completed.

In this embodiment, after the IPA (supercritical substitution solvent) on a semiconductor substrate is dissolved in a supercritical fluid of carbon dioxide, the IPA is put into a supercritical state, and the carbon dioxide and the IPA are vaporized. In this manner, the semiconductor substrate is dried. Since the IPA does not turn into liquid matter when the pressure in the chamber 210 is reduced, agglutination and re-adsorption of the IPA remaining in the chamber 210 can be prevented, and formation of particles can be restrained.

As described above, according to this embodiment, while the particles formed on a semiconductor substrate is reduced, supercritical drying can be performed on the semiconductor substrate.

In this embodiment, IPA is used as the rinse solution (supercritical substitution solvent) in step S103. However, the rinse solution may be ethanol, methanol, hydrofluoroether, alcohol fluoride, diethylether, ethylmethylether, or the like.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A supercritical drying method, comprising:
introducing a semiconductor substrate having a surface wetted with a chemical solution into a chamber;
supplying a supercritical fluid into the chamber;
putting the chemical solution into a supercritical state by adjusting temperature in the chamber to critical temperature of the chemical solution or higher; and
turning the chemical solution in the supercritical state into gaseous matter by lowering pressure in the chamber, and discharging the gaseous matter from the chamber.

2. The supercritical drying method according to claim 1, further comprising:
cleaning the semiconductor substrate by using a second chemical solution;
after cleaning the semiconductor substrate, rinsing the semiconductor substrate by using pure water; and
rinsing the semiconductor substrate by using the chemical solution, the chemical solution being alcohol, after rinsing the semiconductor substrate by using pure water and before introducing the semiconductor substrate into the chamber.

3. The supercritical drying method according to claim 1, wherein the supercritical fluid is maintained in a supercritical state until the chemical solution is put into the supercritical state, and, after the chemical solution is put into the supercritical state, the supercritical fluid is turned into gaseous matter.

4. The supercritical drying method according to claim 3, wherein the pressure in the chamber is maintained at a constant pressure until the chemical solution is put into the supercritical state.

5. The supercritical drying method according to claim 4, wherein, when the pressure in the chamber is reduced, the temperature in the chamber is maintained at the critical temperature of the chemical solution or higher.

6. The supercritical drying method according to claim 1, wherein the supercritical fluid is carbon dioxide.

7. The supercritical drying method according to claim 6, wherein the chemical solution is isopropyl alcohol.

8. The supercritical drying method according to claim 7, wherein the critical temperature is 235.2° C.

9. The supercritical drying method according to claim 6, wherein the chemical solution is one of ethanol, methanol, hydrofluoroether, alcohol fluoride, diethylether, and ethylmethylether.
